(19) United States
(12) Patent Application Publication
(10) Pub. No.: US 2014/0114615 A1
(43) Pub. Date: Apr. 24, 2014

(54) IMAGING APPARATUS AND PROGRAM AND METHOD FOR ANALYZING INTERFERENCE PATTERN

(71) Applicant: Kentaro Nagai, Yokohama-shi (JP)

(72) Inventor: Kentaro Nagai, Yokohama-shi (JP)

(73) Assignee: CANON KABUSHIKI KAISHA, Tokyo (JP)

(21) Appl. No.: 14/125,060

(22) PCT Filed: May 30, 2012
(86) PCT No.: PCT/JP2012/064494

§ 371 Date: Dec. 9, 2013

(30) Foreign Application Priority Data
Jun. 13, 2011 (JP) 2011-131498

(51) Int. Cl. G01T 1/00

(52) U.S. Cl. CPC G01T 1/00
USPC 702/189

(57) ABSTRACT

An imaging apparatus includes a shearing interferometer and a calculation unit configured to calculate information on an object from an interference pattern obtained by the shearing interferometer, wherein the calculation unit solves, as simultaneous equations, three or more equations that express Fourier components at coordinates in a wave number space obtained by performing a windowed Fourier transform on the interference pattern.

### TECHNICAL FIELD

The present invention relates to an imaging apparatus, and in particular, to an imaging apparatus that acquires information on an object by using a shearing interferometer, a program for use in the imaging apparatus, and an analysis method.

### BACKGROUND ART

There is a known technique for imaging and measuring an object by using interference of light with various wavelengths, including X-rays.

A brief description of this technique will be given.

When coherent light is applied to an object, the wavefronts changes depending on the shape and composition of the light. By causing interference of light whose wavefronts have changed by using some method to form an interference pattern (interference fringes) and by analyzing this interference pattern to recover the phase wavefronts, information on the phase, scattering, and absorption of the object can be calculated.

The shearing interferometer is an interferometer that measures the shear images of light using the interference of light, as described above. An interference pattern detected by the shearing interferometer has information on differential wavefront changes caused by the object.

A typical application example of this technique is a wavefront measuring technique for measuring the surface shape of a lens or the like.

Another application example is a technique for acquiring a differential phase image of the object using X-rays.

This technique is for measuring the phase difference of X-rays applied to an object caused by the shape and composition of the object. This technique enables calculation of a differential phase image having information on the internal structure of the object.

The method for calculating wavefront changes of light caused by the object from an interference pattern obtained due to interference is called a phase retrieval method.

There are several kinds of phase retrieval method, one of which is a so-called Fourier transform method. Among them, a method of performing a Fourier transform after multiplying an interference pattern by a window function, as described in NPL 1, is called a windowed Fourier transform method.

The windowed Fourier transform method generally has the characteristic of being higher noise robust as compared with a Fourier transform method that does not use the window function.

### CITATION LIST

### Non Patent Literature

NPL 1 “Windowed Fourier transform method for demodulation of carrier fringes”, Opt. Eng. 43(7) 1472-1473 (July, 2004)

### SUMMARY OF INVENTION

### Technical Problem

The smaller the size of a window function used in a windowed Fourier transform (as a reference, a full width at half maximum is often used), the more the interference pattern can be locally represented by frequency components. Thus, the spatial resolution is improved.

However, there is a problem in that the smaller the size of the window function, the larger overlap between adjacent spectra in a wave number space, thus decreasing the frequency resolution.

Thus, the windowed Fourier transform has a problem in that increasing one of the spatial resolution and the frequency resolution decreases the other.

### Solution to Problem

Accordingly, the present invention provides an imaging apparatus in which influences of overlap between adjacent spectra can be reduced, and a program and method for analyzing an interference pattern which can be used in the imaging apparatus.

An imaging apparatus according to an aspect of the present invention includes a shearing interferometer and a calculation unit configured to calculate information on an object from an interference pattern obtained by the shearing interferometer, wherein the calculation unit solves, as simultaneous equations, three or more equations that express Fourier components at coordinates in a wave number space obtained by performing a windowed Fourier transform on the interference pattern.

The other aspects of the present invention will be shown in an embodiment described below.

### Advantageous Effects of Invention

The present invention can provide an imaging apparatus in which influences of overlap between adjacent spectra can be reduced when performing phase retrieval using a windowed Fourier transform, and a program and method for analyzing an interference pattern which can be used in the imaging apparatus.

### BRIEF DESCRIPTION OF DRAWINGS

FIG. 1 is a schematic diagram of an imaging apparatus of an embodiment of the present invention.

FIG. 2A is a schematic diagram of an example of a diffraction grating used in a one-dimensional Talbot interferometer.

FIG. 2B is a schematic diagram of an example of an interference pattern used in the one-dimensional Talbot interferometer.

FIG. 2C is a schematic diagram of an example of an absorption grating used in the one-dimensional Talbot interferometer.

FIG. 3A is a schematic diagram of a diffraction grating used in a two-dimensional Talbot interferometer.

FIG. 3B is a schematic diagram of an interference pattern used in the two-dimensional Talbot interferometer.

FIG. 3C is a schematic diagram of an example of an absorption grating used in the two-dimensional Talbot interferometer.

FIG. 4A is a schematic diagram of a wave number space for explaining coordinates used in phase retrieval of the embodiment.

FIG. 4B is a schematic diagram of a wave number space for explaining coordinates used in phase retrieval of the embodiment.

FIG. 5A is a schematic diagram of an object used in simulations of an example and a comparative example.

FIG. 5B is a schematic diagram of moire used in the simulations of the example and the comparative example.

FIG. 6A is an X-direction differential phase image of 128×128 pixels acquired in the example.

FIG. 6B is a Y-direction differential phase image of 128×128 pixels acquired in the example.

FIG. 7A is an X-direction differential phase image of 128×128 pixels acquired in the comparative example.

FIG. 7B is a Y-direction differential phase image of 128×128 pixels acquired in the comparative example.

FIG. 8A is an image diagram of a sequential phase transform in the windowed Fourier transform method.

FIG. 8B is an image diagram of a sequential phase transform in the windowed Fourier transform method.

### DESCRIPTION OF EMBODIMENT

From a close study, the inventor of the present invention has found that phase retrieval may be performed in consideration of influences of overlap between adjacent spectra in a wave number space in order to improve the spatial resolution while maintaining the frequency resolution or to improve the frequency resolution while maintaining the spatial resolution. An example of the method for performing phase retrieval in consideration of influences of overlap between spectra is a method of performing phase retrieval while separating adjacent spectra by spectrum fitting.

However, a large amount of data has to be treated to perform spectrum fitting. Suppose that an image of, for example, 1,000×1,000 pixels is acquired. When a Fourier transform is performed by applying window functions, with the individual pixels as the centers thereof, data on a wave number space of 1,000×1,000 pixels is obtained for each of the pixels of the original image. As a result, the data totals to the fourth power of 1,000, and hence much time or a large number of computer resources is needed to separate the spectra and recover the phases thereof.

Thus, an imaging apparatus that performs the foregoing method for performing phase retrieval in a shorter time or with lower resources than the method of separating spectra by spectrum fitting will be described hereinbelow with reference to the attached drawings. In the drawings, the same components are given the same reference numerals, and duplicated descriptions are omitted.

In this embodiment, an imaging apparatus that employs a Talbot interferometer as the shearing interferometer will be described. However, this embodiment can also be applied to shearing interferometers in various forms other than the Talbot interferometer.

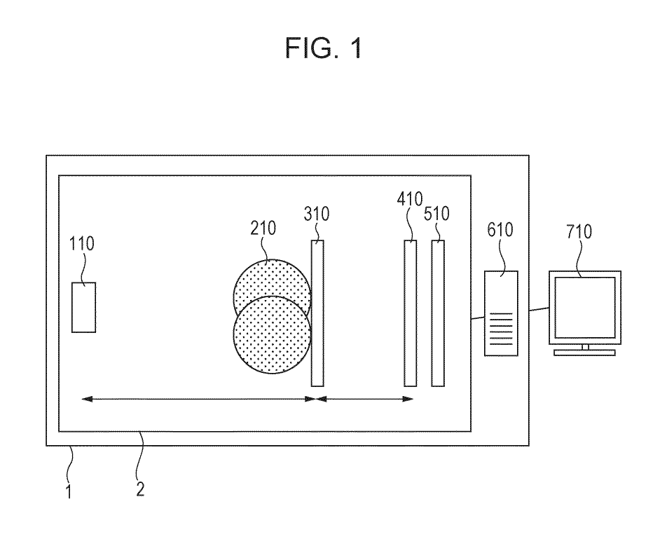

FIG. 1 is a diagram illustrating the configuration of the imaging apparatus of this embodiment. The imaging apparatus 1 shown in FIG. 1 includes a Talbot interferometer 2 and a computer 610 serving as a calculation unit. The Talbot interferometer 2 includes an X-ray source 110 serving as a light source, a diffraction grating 310 that diffracts X-rays, an absorption grating 410 that shields part of X-rays, and a detector 510 that detects X-rays. The imaging apparatus 1 is connected to an image display apparatus 710 that displays an image based on the calculation result of the computer 610 to constitute an image pickup system.

The individual configurations will be described hereinbelow.

The X-ray source 110 may be any of an X-ray source that emits continuous X-rays, an X-ray source that emits characteristic X-rays, an X-ray source that emits parallel X-rays (parallel rays), and an X-ray source that emits divergent X-rays (spherical divergent rays). However, X-rays in this specification refers to light whose energy is 2 keV or more and 100 keV or less.

Since X-rays emitted from the X-ray source 110 has to form an interference pattern by being diffracted by the diffraction grating 310, it is necessary that the X-rays from the X-ray source 110 have sufficient spatial coherence to form an interference pattern.

The X-rays from the X-ray source 110 are diffracted by the diffraction grating 310 to form an interference pattern in which bright portions and dark portions are arrayed at a predetermined distance called Talbot distance therefrom. In this specification, portions at which the intensity of the X-rays (bright) is high are referred to as bright portions, and portions at which the intensity is low are referred to as dark portions.

The diffraction grating 310 used in this embodiment is a phase diffraction grating. Although an amplitude diffraction grating may be used as the diffraction grating, the phase diffraction grating is more advantageous because a loss in the X-rays (light intensity) is lower with the phase diffraction grating.

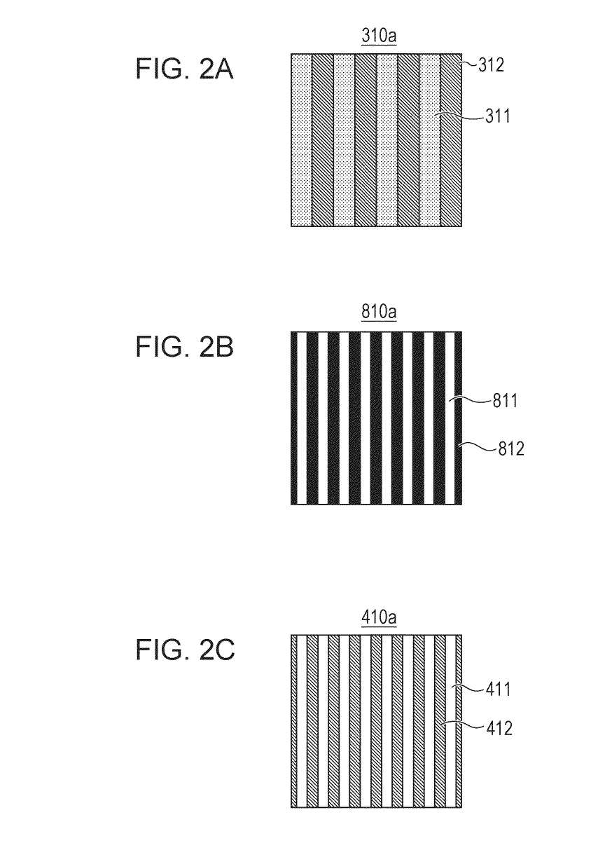

FIG. 2A is a top view of an example of the configuration of a phase grating 310a that forms a one-dimensional interference pattern, in which reference numeral 311 denotes reference portions of the phase, and reference numeral 312 denotes portions in which the phase changes with respect to the reference portions 311 by an amount π. FIG. 2B shows bright portions 811 and dark portions 812 of an interference pattern 810a formed by the phase grating 310a.

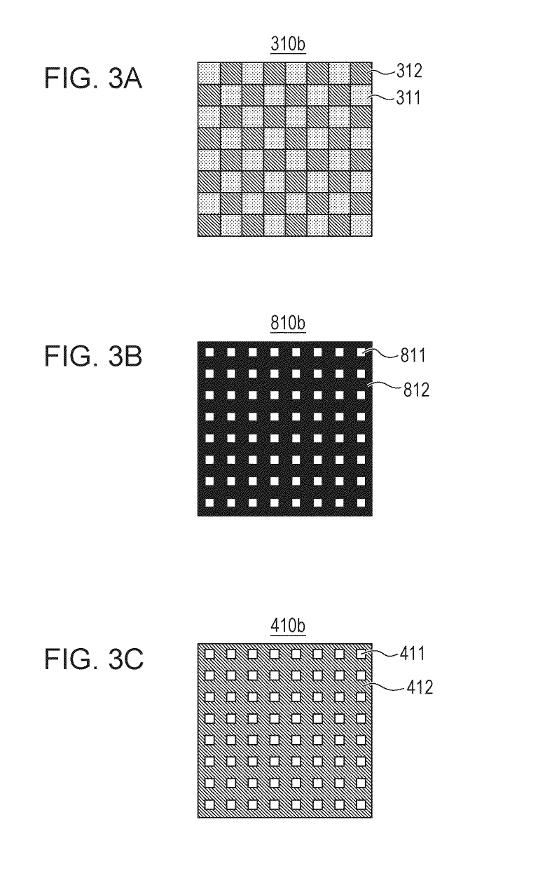

FIG. 3A is a top view of an example of the configuration of a phase grating 310b that forms a two-dimensional interference pattern, in which reference numeral 311 denotes reference portions of the phase, and reference numeral 312 denotes portions in which the phase changes with respect to the reference portions 311 by an amount π. FIG. 3B shows bright portions 811 and dark portions 812 of an interference pattern 810b formed by the phase grating 310b.

The absorption grid 410 has a structure in which transmitting portions that allow X-rays to pass therethrough and shield portions that block X-rays are arrayed and is disposed at a Talbot distance from the diffraction grating 310. This allows part of X-rays that form an interference pattern to be blocked by the absorption grating 410 and thus, X-rays that have passed through the absorption grating 410 form moire. Since the shield portions need only block the X-rays so as to allow the X-rays that have passed through the absorption grating 410 to form moire, they need not completely block the X-rays.

In the case of a Talbot interferometer that uses X-rays as light, the period of the interference pattern formed by a diffraction grating ranges generally from a few μm to a few tens μ at the maximum, while the resolution of a general X-ray detector ranges from about a few tens μm to a few hundred μm. Therefore, it is difficult to directly detect the interference pattern. Thus, a method of forming moire by using the absorption grating 410 and detecting the moire is often used, as in this embodiment. In the case where moire is formed in this way, the pitch of the absorption grating 410 may be either the same as that of the interference pattern or slightly different therefrom and can be determined depending on the pitch of intended moire. The pitch of the moire changes also depending on an angle formed by a direction in which the shield portions and the transmitting portion of the absorption grating 410 are arrayed and a direction in which the bright portions and the dark portions of the interference pattern are arrayed. Although the period of moire can take various values, a desired period generally corresponds to three pixels of the detection device of the detector 510.

FIG. 2C is a top view of an example of the configuration of an absorption grating 410a used to form the interference pattern 810a in FIG. 2B. FIG. 3C is a top view of an example of the configuration of an absorption grating 410b used to form the interference pattern 810b in FIG. 3B. Both the absorption grating 410a in FIG. 2C and the absorption grating 410b in FIG. 3C are configured such that transmitting portions 411 and shield portions 412 are periodically arrayed.

The combinations of the diffraction gratings and the absorption gratings shown in FIGS. 2A to 2C and FIGS. 3A to 3C are merely examples; another combination can also be used. This embodiment does not depend on the configuration of the gratings. When the interference pattern is to be directly detected, the absorption grating 410 is not needed.

The detector 510 includes a detection device (for example, a CCD) capable of detecting X-rays and detects the intensity distribution of moire formed through the absorption grating 410. Although the imaging apparatus of this embodiment detects the intensity distribution of moire, the intensity distribution of an interference pattern may be directly detected and analyzed. Although this embodiment has been described as applied to an example in which the interference pattern and the moire are distinguished from each other, it is also possible to regard the moire as a kind of interference pattern. That is, although this embodiment is described using moire because moire is detected and the detected moire is analyzed, an interference pattern that is directly detected can also be analyzed as in the case where moire is detected.

The computer 610 calculates information on a differential phase image of the object 210 on the basis of the detection result of the detector 510 of the Talbot interferometer 2.

To describe a calculation method (a phase retrieval method) performed by the computer 610, first, the phase retrieval method involving calculating information on the differential phase image while separating spectra by spectrum fitting will be described as a comparative example.

A two-dimensional windowed Fourier transform is defined by the following equation.

[Math 1]

WF[f(x, y)](u, v, kₓk_{y})=∫f(x, y)g(x−u, y−v)e^{-ik}ₓ^{x-ik}_{y}^{y} dxdy Eq. 1

where, f(x, y) is an original function, g(x, y) is a window function, (x, y) is coordinates, (u, v) is the center of the window function, and (kₓ, k_{y}) is a wave number. WF[. . . ] is an operator indicating that a windowed Fourier transform is performed on the function within the brackets. When the intensity distribution I(x, y) of some moire is subjected to a windowed Fourier transform, a wave number space can be obtained for each of the central positions (u, v) of the individual window functions.

For example, when a discrete image of 1,000×1,000 pixels (in this embodiment, the intensity distribution of moire) is subjected to a windowed Fourier transform, a wave number space of 1,000×1,000 pixels is obtained for each of windows whose window functions are centered at the individual pixels of the image. That is, 1,000×1,000 wave number spaces of 1,000×1,000 pixels are obtained. This means that information on the image of 1,000×1,000 pixels is converted to information of the fourth power of 1,000.

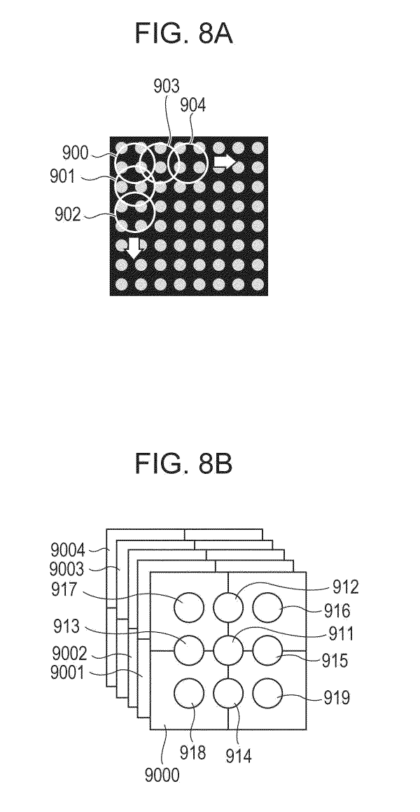

This is illustrated in FIGS. 8A and 8B. FIG. 8A is a schematic diagram of moire I(x, y). A region 900 cut out by a window function g(u, v) is centered at given coordinates (u, v). When this region 900 is subjected to a Fourier transform, a wave number space 9000, as shown in FIG. 8B, is obtained. This wave number space 9000 includes spectra, such as a zero-order spectrum 911, first-order spectra 912, 913, 914, and 915, from which information on phase changes of the wavefronts of X-rays, the amount of X-rays absorbed, and scattering of X-rays by the object can be calculated. The first-order spectra are spectra that stem from the period of moire.

Such wave number spaces are generally calculated for the individual center coordinates (u, v) of window functions.

That is, when a region 901 whose center coordinates of the window function are changed from the region 900 is subjected to a Fourier transform, a wave number space 9001 is obtained. Similarly, when a region 902 is subjected a Fourier transform, a wave number space 9002 is obtained. When a region 903 is subjected to a Fourier transform, a wave number space 9003 is obtained, and when a region 904 is subjected to a Fourier transform, a wave number space 9004 is obtained.

If the radius of the region 900 that is cut off in a windowed Fourier transform, as described above, is reduced, adjacent spectra may overlap with each other.

Thus, the adjacent spectra are separated. Since the spectra 911 to 914 seem to be subjected to fitting in the shape of the window functions, the spectra are separated using fitting of this method in this comparative example.

For example, if a Gaussian window is used as the window function, the window for the Fourier transform is the same Gaussian window, and thus, spectra on the wave number spaces may also be subjected to fitting using the Gaussian window.

However, to perform fitting using the Gaussian window, it is necessary to execute a windowed Fourier transform for all combinations of (u, v) to calculate Fourier components at all coordinates in the wave number space, as shown in FIG. 8B. Therefore, to perform phase retrieval using an image of 1,000×1,000 pixels, it is necessary to perform phase retrieval using “a wave number space corresponding to 1,000×1,000 pixels” for each of the obtained wave number spaces by executing windowed Fourier transforms, with all the pixels as the centers of window functions, as described above. Thus, phase retrieval takes a great deal of time. In particular, an increase in image size will exponentially increase calculation time or the number of computer resources necessary for phase retrieval.

Thus, in this embodiment, the amount of calculation is reduced by performing phase retrieval by calculating Fourier components of a few of the combinations of (kₓ, k_{y}) in Eq. 1 without creating a map of the wave number spaces (kₓ, k_{y}).

The method for phase retrieval performed by the computer 610 of this embodiment will be described.

First, assume two-dimensional phase imaging, and assume that moire can be approximately described in the following form:

$$\begin{matrix}[ Math 2 ] & \\ \begin{matrix}I ( x , y ) = a ( x , y ) + b ( x , y ) cos ( {ω}_{1} x + {P}_{1} ( x , y ) ) + \\ cos ( {ω}_{1} x + {P}_{1} ( x , y ) ) \\ = a ( x , y ) + \frac{b ( x , y )}{2} \{ exp ( i ( {w}_{1} x + {P}_{1} ( x , y ) ) ) + \\ exp ( - i ( {ω}_{1} x + {P}_{1} ( x , y ) ) ) \} \\ + \frac{b ( x , y )}{2} \{ \begin{matrix}exp ( i ( {ω}_{2} x + {P}_{2} ( x , y ) ) ) + \\ exp ( - i ( {ω}_{2} x + {P}_{2} ( x , y ) ) )\end{matrix} \}\end{matrix} & Eq . 2\end{matrix}$$

where, a(x, y) is the amount of light absorbed by the object, and b(x, y) is the amplitude of the moire. P₁(x, y) and P₂(x, y) are phases to be measured. They can take different values depending on the positions. Values ω₁ and ω₂ are the periods of the moire in the x- and Y-directions, respectively. The shape of the moire is not limited to a shape expressed by Eq. 2; it is merely an example, and this embodiment can be applied to various kinds of moire (interference pattern). For example, moire that is not along the x-axis direction and the y-axis direction of the screen is expressed by an equation that is more complicated than Eq. 2. Although not described in detail, this can be expressed by Eq. 2 by performing rotational transform or the like.

If the third term in Eq. 2 is set to 0, Eq. 2 expresses one-dimensional moire. The description below can also be applied to the one-dimensional moire.

Substitute Eq. 2 into Eq. 1. Here, assume that the width of the window function g(x, y) is sufficiently small, and that the foregoing a(x, y), b(x, y), P₁(x, y), and P₂(x, y) can be approximated as fixed values within their ranges. Therefore, they are abbreviated as a, b, P₁, and P₂, respectively, in the following description. The Fourier transform of the window function g(x, y) is described as G(x, y).

Substituting Eq. 2 into Eq. 1 yields Eq. 3 below.

$$\begin{matrix}[ Math 3 ] & \\ WF [ I ( x , y ) ] ( u , v , {k}_{x} , {k}_{y} ) = aG ( {k}_{x} , {k}_{y} ) exp ( - i {k}_{x} u ) exp ( - i {k}_{y} v ) + \frac{b}{2} exp [ - i {P}_{1} ] exp [ - i ( {k}_{x} + {ω}_{1} ) u ] exp ( - i {k}_{y} v ) G ( {k}_{x} + {ω}_{1} , {k}_{y} ) + \frac{b}{2} exp [ i {P}_{1 } ] exp [ - i ( {k}_{x} - {ω}_{1} ) u ] exp ( - i {k}_{y} v ) G ( {k}_{x} - {ω}_{1} , {k}_{y} ) + \frac{b}{2} exp [ - i {P}_{2} ] exp ( - i {k}_{x} u ) exp [ - i ( {k}_{y} + {ω}_{2} ) v ] G ( {k}_{x} , {k}_{y} + {ω}_{2} ) + \frac{b}{2} exp [ i {P}_{2} ] exp ( - i {k}_{x} u ) exp [ - i ( {k}_{y} - {ω}_{2} ) v ] G ( {k}_{x} , {k}_{y} - {ω}_{2} ) & Eq . 3\end{matrix}$$

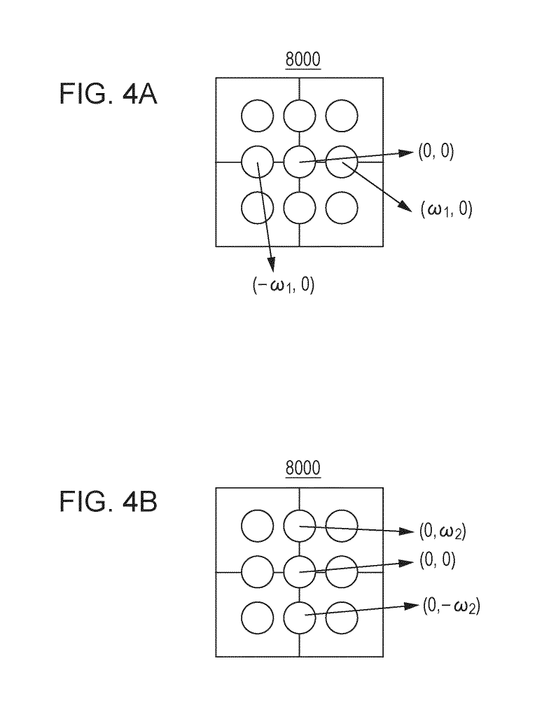

FIGS. 4A and 4B are diagrams illustrating a map 8000 of a wave number space (kₓ, k_{y}) obtained when a windowed Fourier transform is performed, with the center coordinates at (u, v) in two-dimensional phase imaging. In this embodiment, although Fourier components at a few points in the wave number space are calculated without creating such a map, as described above, such a map 8000 is used here to describe this embodiment.

Here, (0, 0) is the point of origin, which indicates the peak position of a zero-order spectrum, and (ω₁, 0), (−ω₁, 0), (0, ω₂), and (0, −ω₂) indicate the peaks of first-order spectra of the two-dimensional moire. A method for performing phase retrieval using (0, 0), (ω₁, 0), and (−ω₁, 0), as shown in FIG. 4A, will be described hereinbelow.

The phase is recovered using equations expressing Fourier components at the three coordinates. The values of Fourier components at the individual coordinates can be expressed as follows from Eq. 3.

$$\begin{matrix}[ Math 4 ] & \\ WF [ I ( x , y ) ] ( u , v , 0 , 0 ) = aG ( 0 , 0 ) + \frac{b}{2} exp [ - i {P}_{1} ] exp [ - {iω}_{1} , 0 ] G ( {ω}_{1 } , 0 ) + \frac{b}{2} exp [ i {P}_{1} ] exp [ - i ( - {ω}_{1} ) u ] G ( - {ω}_{1} , 0 ) + \frac{b}{2} exp [ - i {P}_{2} ] exp [ - i ( {ω}_{2} ) v ] G ( 0 , {ω}_{2} ) + \frac{b}{2} exp [ i {P}_{2} ] exp [ - i ( - {ω}_{2} ) v ] G ( 0 , - {ω}_{2} ) & Eq . 4 \\ [ Math 5 ] & \\ WF [ I ( x , y ) ] ( u , v , {ω}_{1} , 0 ) = aG ( {ω}_{1} , 0 ) exp ( - {iω}_{1} u ) + \frac{b}{2} exp [ - {iP}_{1} ] exp [ - i ( 2 {ω}_{1} ) u ] G ( 2 {ω}_{1} , 0 ) + \frac{b}{2} exp [ {iP}_{1} ] G ( 0 , 0 ) + \frac{b}{2} exp [ - {iP}_{2} ] exp ( - {iω}_{1} u ) exp [ - i ( {ω}_{2} ) v ] G ( {ω}_{1} , {ω}_{2} ) + \frac{b}{2} exp [ {iP}_{2} ] exp ( - {iω}_{1} u ) exp [ - i ( - {ω}_{2} ) v ] G ( {ω}_{1} , - {ω}_{2} ) & Eq . 5 \\ [ Math 6 ] & \\ WF [ I ( x , y ) ] ( u , v , - {ω}_{1} , 0 ) = aG ( - {ω}_{1} , 0 ) exp ( + {iω}_{1} u ) + \frac{b}{2} exp [ - {iP}_{1} ] G ( 0 , 0 ) + \frac{b}{2} exp [ {iP}_{1} ] exp [ + i ( 2 {ω}_{1} ) u ] G ( - 2 {ω}_{1} , 0 ) + \frac{b}{2 } exp [ - {iP}_{2} ] exp ( + {iω}_{1} u ) exp [ - i ( {w}_{2} ) v ] G ( - {ω}_{1} , {ω}_{2} ) + \frac{b}{2} exp [ {iP}_{2} ] exp ( + {iω}_{1} u ) exp [ - i ( - {ω}_{2} ) v ] G ( {ω}_{1} , {ω}_{2} ) & Eq . 6\end{matrix}$$

Since points (ω₁, 0) and (−ω₁, 0) are symmetrical about the point of origin and has a complex conjugate relation, Eq. 6 can be given from Eq. 5.

Eq. 4, Eq. 5, and Eq. 6 are solved as simultaneous equations.

Multiplying Eq. 4 by exp(−ω₁u)G(ω₁, 0) and calculating a difference between it and Eq. 5 yield the following equation:

$$\begin{matrix}[ Math 7 ] & \\ WF [ I ( x , y ) ] ( u , v , 0 , 0 ) \times exp [ - {iω}_{1} u ] G ( {ω}_{1} , 0 ) - WF [ I ( x , y ) ] ( u , v , {ω}_{1} , 0 ) = \frac{b}{2} exp [ - i {P}_{1} ] exp [ - {iω}_{1} u ] G ( {ω}_{1} , 0 ) \times exp [ - {iω}_{1} u ] G ( {ω}_{1} , 0 ) - \frac{b}{2} exp [ - i {P}_{1} ] exp [ - {iω}_{1} u ] G ( 2 {ω}_{1} , 0 ) + \frac{b}{2 } exp [ i {P}_{1} ] exp [ - i ( - {ω}_{1} ) u ] G ( - {ω}_{1} , 0 ) \times exp [ - {iω}_{1} u ] G ( {ω}_{1} , 0 ) - \frac{b}{2} exp [ i {P}_{1} ] exp [ + {iω}_{1} u ] G ( 0 , 0 ) = \frac{b}{2} \{ exp [ - i {P}_{1} - {iω}_{1} u ] G ( 2 {ω}_{1} , 0 ) ( exp [ - {iω}_{1} u ] - 1 ) + exp [ + i {P}_{1} ] ( G ( 2 {ω}_{1} , 0 ) - G ( 0 , 0 ) exp [ + {iω}_{1} u ] ) \} & Eq . 7\end{matrix}$$

Similarly, multiply Eq. 4 by exp(+ω₁u)G(−ω₁, 0) and taking a difference between it and Eq. 6 yield the following equation:

$$\begin{matrix}[ Math 8 ] & \\ WF [ I ( x , y ) ] ( u , v , 0 , 0 ) \times exp [ {iω}_{1} u ] G ( - {ω}_{1} , 0 ) - WF [ I ( x , y ) ] ( u , v , {ω}_{1} , 0 ) = \frac{b}{2} exp [ - i {P}_{1} ] exp [ - {iω}_{1} u ] G ( {ω}_{1} , 0 ) \times exp [ {iω}_{1} u ] G ( - {ω}_{1} , 0 ) - \frac{b}{2} exp [ - i {P}_{1} ] exp [ - {iω}_{1} u ] G ( 0 , 0 ) + \frac{b}{2 } exp [ i {P}_{1} ] exp [ - i ( - {ω}_{1} ) u ] G ( - {ω}_{1} , 0 ) \times exp [ {iω}_{1} u ] G ( {ω}_{1} , 0 ) - \frac{b}{2} exp [ i {P}_{1} ] exp [ + {iω}_{1} u ] G ( - 2 {ω}_{1} , 0 ) = \frac{b}{2} \{ exp [ - i {P}_{1} ] G ( 2 {ω}_{1} , 0 ) - G ( 0 , 0 ) exp [ + {iω}_{1} u ] ) + exp [ + i {P}_{1} + {iω}_{1} u ] ( G ( - 2 {ω}_{1} , 0 ) ( exp [ {iω}_{1} u ] - 1 ) \} & Eq . 8\end{matrix}$$

Note that deriving the above equation requires considering the following characteristics as the characteristics of the Fourier transform of the window function.

G(−ωₐ, ω_{b})=G(ωₐ, ω_{b}) . . . (the same applies to y components)
G(ωₐ, ω_{c})G(ω_{b}, ω_{c})=G(ωₐ+ω_{b}, ω_{c}) . . . (the same applies to y components)

Therefore, the fourth term and the fifth term in Eq. 4 cancel the fourth terms and the fifth terms of Eq. 5 and Eq. 6.

Thus, Eq. 7 and Eq. 8 can be derived from the equations expressing the Fourier components at the three coordinates (0, 0), (ω₁, 0), and (−ω₁, 0).

Substituting the values of the Fourier components, (WF[I(x, y)](u, v, 0, 0), WF[I(x, y)](u, v, ω₁, 0), WF[I(x, y)](u, v, −ω₁, 0)) and the values of Fourier transforms of the window functions, (G(ω₁, 0), G(0, 0), G(−ω₁, 0), G(2ω₁, 0), G(−2ω₁, 0)), calculated from the detection results, into Eq. 7 and Eq. 8 allows b and P₁ to be calculated in the form of simultaneous equations.

Here, since (ω₁, 0) and (−ω₁, 0) are symmetrical about the point of origin and has a complex conjugate relation, the values of Fourier components at the two coordinates are equal. This allows b and P₁ to be calculated using the values of Fourier components at only two coordinates (0, 0) and (ω₁, 0), or (0, 0) and (−ω₁, 0). That is, in this embodiment, three equations that express Fourier components at coordinates in a wave number space are used, and simultaneous equations derived from the equations that express the Fourier components are solved using the values of Fourier components at two coordinates in the wave number space. Here, the two coordinates in the wave number space refer to first coordinates (here, the point of origin) and second coordinates (here, (ω₁, 0) or (−ω₁, 0)), which differ from the first coordinates and are not symmetrical about the first coordinates and the point of origin.

By performing calculations using (0, 0), (0, ω₂), and (0, −ω₂), shown in FIG. 4B, in the same way, P₂ can be found. Value a can also be found by substituting the found b, P₁, and P₂ into any of Eq. 4, Eq. 5, and Eq. 6. Thus, the four values, a, b, P₁, and P₂, assumed in Eq. 3, can be found using the complex conjugate relation by using the values of Fourier components at substantially three coordinates.

An absorption image, a scattering image, and a differential phase image of the object can be acquired from the values, a, b, P₁, and P₂, and furthermore, a phase image can be acquired by integrating the differential phase image.

Thus, using this embodiment allows a phase retrieval method that uses a windowed Fourier transform to be performed at higher speed and with lower resources than spectrum fitting as in the comparative example.

The above example has been described using an example in which the peak of the zero-order spectrum and the peaks of first-order spectra are used. However, the combination and number of coordinates (kₓ, k_{y}) in the wave number space for use in calculation of a, b, P₁, and P₂ are not limited thereto. In this embodiment, although values a, b, P₁, and P₂ are calculated using five equations expressing Fourier components by solving simultaneous equations derived from these equations, the values a, b, P₁, and P can be calculated as the number of coordinates used increases. For example, a plurality of values of P₁ may be found by a plurality of simultaneous equations expressing Fourier components, and then P₁ may be finally found using a least squares method. Note that the accuracy of values a, b, P₁, and P₂ calculated is not improved even by using equations exceeding R², where R is the section of the window function in units of pixels of the detector. This is because a wave number space obtained by a windowed Fourier transform includes only information on pixels within the region of the original window function. On the other hand, the larger the number of coordinates used, the larger the amount of calculation. Thus, the number of equations used may be five or more and R² or less. In the case where there is no need to find P₂, such as a case where one-dimensional moire is subjected to phase retrieval or a case where a one-dimensional differential phase image is desired, three or more equation expressing Fourier components may be used. Also in this case, the use of the complex conjugate relation allows the values of a, b, and P₁ to be calculated from the values of Fourier components at two coordinates, as in the above. In this specification, the one-dimensional differential phase image is an image acquired by differentiating a phase image in one direction. If there is no need to find the value of P₂, the accuracy of values a, b, and P₁ calculated is not improved even by using equations at coordinates exceeding R, and thus, three or more and R or less equations expressing Fourier components at coordinates may be used. In addition, if a Gaussian window is used, pixels within ±3σ, which is a region in which 99% of information is present, is used as the section of the window function, where σ is the variance of the Gaussian window.

Some moire has not only the zero-order or first-order spectra but also higher-order spectra. Even if the peaks of higher-order spectra are used, simultaneous equations can be similarly written and calculated. For example, a method of using secondary spectra, such as spectra 916, 917, 918, and 919 shown in FIG. 8B, may also be used.

The coordinates used need not be the peaks of spectra. Coordinates at which the absolute value of the Fourier component is large may be used, because it is less prone to being influenced by noise.

Furthermore, the coordinates used may be on the X-axis or the Y-axis, because it simplifies calculation as compared with a case in which coordinates that are present not on the X- or Y-axis are used.

Although this embodiment uses the complex conjugate relation to simplify calculations by the computer 610, phase recover can be performed even if the complex conjugate relation is not used. In this case, three or more values of Fourier components substituted into simultaneous equations are needed.

The windowed Fourier transform can also be expressed as follows using the convolution theory. Assuming that the window function is an odd function symmetrical about the point of origin, that is, g(x)=g(−x), the following equation hold.

$$\begin{matrix}[ Math 9 ] & \\ \begin{matrix}WF [ f ( x , y ) ] ( u , v , {k}_{x} , {k}_{y} ) = \int f ( x , y ) g ( x - u , y - v ) \\ {e}^{- i {k}_{x} x - i {k}_{y} y} d x d y \\ = {e}^{- i {k}_{x} u - i {k}_{y} v} \int f ( x , y ) g ( u - x , v - y ) \\ {e}^{i {k}_{x} ( u - x ) + i {k}_{y} ( v - y )} d x d y \\ = {e}^{- i {k}_{x} u - i {k}_{y} v} {F}^{- 1} [ F [ f ( x , y ) ] \cdot \\ F [ g ( u - x , v - y ) {e}^{i {k}_{x} ( u - x ) + i {k}_{y} ( v - y )} 〛\end{matrix} & Eq . 9\end{matrix}$$

where F[ . . . ] is a normal Fourier transform, and F⁻¹[ . . . ] is an inverse Fourier transform. Eq. 9 shows that multiplying a Fourier transform F[f(x, y)] of the original function by a window function, F[g(u−x, v−y)exp[ikₓ(u−x)+ik_{y}(v−y)]], in the wave number space and finding its inverse Fourier transform is the same as executing a Fourier transform after multiplying the original function by the window function. In this embodiment, although phase retrieval is performed using Eq. 1, Eq. 9 may be used to perform phase retrieval.

The phase retrieval method using the computer 610 has been described above. To perform the foregoing calculations using the computer 610, a program for executing the above calculations may be installed in the computer 610.

### Examples

The results of simulations of phase retrieval using the imaging apparatus described in the embodiment will be shown as examples.

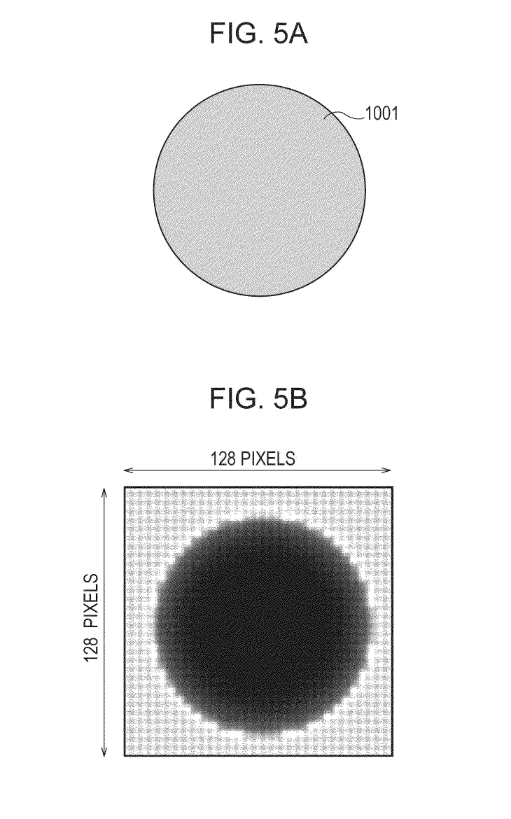

A simulation was executed using the imaging apparatus 1 equipped with the phase grating 310b shown in FIG. 3A serving as a diffraction grating, the absorption grating 410b shown in FIG. 3C serving as an absorption grating, and a 128 - by 128-pixel detector serving as a detector. For the object, a spherical object 1001, as shown in FIG. 5A, was used. The simulation was performed on the object 1001 disposed at the center of the detection region of the detector.

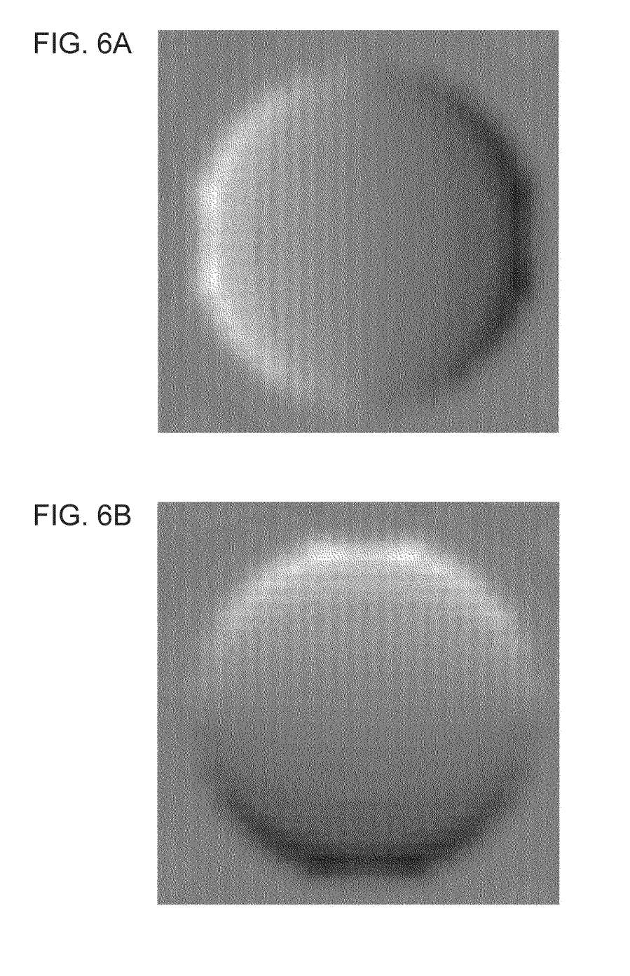

FIG. 5B illustrates moire detected for the object 1001 in FIG. 5A by the 128 - by 128-pixel detector. Differential phase images acquired from the detection result by the foregoing phase retrieval method are shown in FIGS. 6A and 6B. FIG. 6A illustrates an X-direction differential phase image, and FIG. 6B illustrates a Y-direction differential phase image.

Similar simulations were performed using the detection results of 256 - by 256-pixel and 512 - by 512-pixel detectors, and actual times taken for calculations were listed on Table 1. The calculation times were, 0.5 seconds, 0.7 seconds, and 1.5 seconds.

### Comparative Example

Simulation results of phase retrieval using the same method as in the foregoing comparative example examples will be shown, as in the example. An imaging apparatus of this comparative example differs from the examples only in the phase retrieval method performed by the computer, and the other configurations are the same as those of the examples.

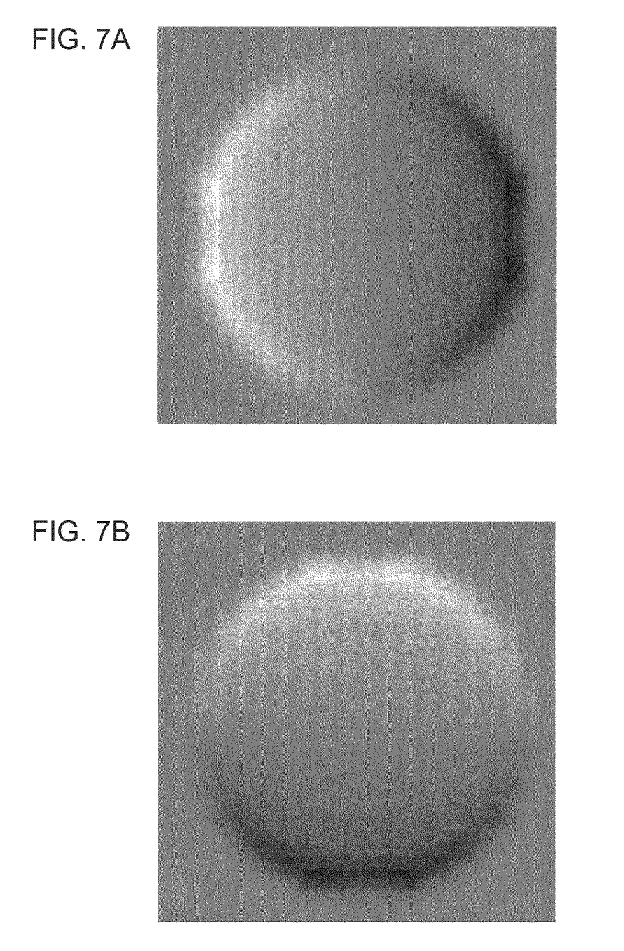

Since it is difficult to calculate the entire windowed Fourier space at a time because of the computer resources used, the phase retrieval was performed by performing a windowed Fourier transform for all of combinations of (u, v), and determining the differential phases of (u, v) one after another. As in the examples, differential phase images acquire using the detection result shown in FIG. 5B are illustrated in FIGS. 7A and 7B. FIG. 7A illustrates an X-direction differential phase image, and FIG. 7B illustrates a Y-direction differential phase image.

A comparison between FIG. 6A and FIG. 7A and a comparison between FIG. 6B and FIG. 7B show that similar differential phase images are acquired.

Similar simulations were performed using the detection results of 256 - by 256-pixel and 512 - by 512-pixel detectors, as in the examples, and actual times taken for calculations were listed on Table 1. This shows that exponentially long calculation times were taken, that is, 105 seconds, 1,044 seconds, and 20,938 seconds, depending on the number of pixels.

This also shows that the actual times taken for calculations are reduced in the examples.

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., non-transitory computer-readable medium).

As described above, this embodiment performs phase retrieval by calculating the Fourier components of only part, not all, of the coordinates in wave number spaces by using equations expressing the values of Fourier components obtained by a windowed Fourier transform. This allows a phase retrieval method using a windowed Fourier transform to be executed in a short time or with low resources. Thus, the present invention is not limited to the foregoing embodiment, and various changes and modifications can be made within the spirit of the invention. Accordingly, the claims below are attached to disclose the scope of the present invention.

This application claims the benefit of Japanese Patent Application No. 2011-131498, filed Jun. 13, 2011, which is hereby incorporated by reference herein in its entirety.

TABLE 1

| Image Size | Example | Comparative Example |
|---|---|---|
| 128 × 128 | 0.5 sec. | 105 sec. |
| 256 × 256 | 0.7 sec. | 1,044 sec. |
| 512 × 512 | 1.5 sec. | 20,938 sec. |

### REFERENCE SIGNS LIST

1 shearing interferometer

2 imaging apparatus

610 computer

1. An imaging apparatus comprising:
a shearing interferometer; and
a calculation unit configured to calculate information on an object from an interference pattern obtained by the shearing interferometer,
wherein the calculation unit solves, as simultaneous equations, three or more equations that express Fourier components at coordinates in a wave number space obtained by performing a windowed Fourier transform on the interference pattern.

2. The imaging apparatus according to claim 1, wherein
the information on the object is information on at least one of an absorption image, a scattering image, a differential phase image, and a phase image of the object.

3. The imaging apparatus according to claim 1, wherein
the calculation unit calculates information on at least one of a one-dimensional absorption image, a one-dimensional scattering image, a one-dimensional differential phase image, and a one-dimensional phase image by using three or more and R or less equations that express the Fourier components, where R is the section of a window function in units of pixels of a detector.

4. The imaging apparatus according to claim 1, wherein
the calculation unit calculates information on at least one of a two-dimensional absorption image, a two-dimensional scattering image, a two-dimensional differential phase image, and a two-dimensional phase image by using five or more and R² or less equations that express the Fourier components, where R is the section of a window function in units of pixels of a detector.

5. The imaging apparatus according to claim 1, wherein at least one of the equations that express the Fourier components expresses the Fourier component that stems from the period of the interference pattern.

6. The imaging apparatus according to claim 1, wherein one of the equations that express the Fourier components expresses the Fourier component at the point of origin of the wave number space.

7. The imaging apparatus according to claim 1, wherein the simultaneous equations are solved by using values found by calculating the Fourier components at two or more coordinates in the wave number space.

8. The imaging apparatus according to claim 1, wherein at least two of the equations that express the Fourier components express the Fourier components at two coordinates that have the relation of point symmetry about the point of origin of the wave number space.

9. The imaging apparatus according to claim 1, wherein the equations that express the Fourier components express the Fourier components at an X-axis coordinate or a Y-axis coordinate in the wave number space.

10. A computer program stored on a non-transitory computer readable storage medium, the program being for calculating information on an object by solving, as simultaneous equations, three or more equations that express Fourier components at coordinates in a wave number space obtained by performing a windowed Fourier transform on an interference pattern obtained by a shearing interferometer.

11. A method for obtaining information on an object from an interference pattern obtained by a shearing interferometer, the method comprising solving, as simultaneous equations, three or more equations that express Fourier components at coordinates in a wave number space obtained by performing a windowed Fourier transform on the interference pattern.

12. The imaging apparatus according to claim 1, wherein each of the equations that express the Fourier components is obtained by obtaining an equation by substituting an equation expressing the interference pattern into [Math 1] below defining a windowed Fourier transform and by substituting the coordinates in the wave number space into the obtained equation:
WF[f(x, y)](u, v, kₓ, k_{y})=∫f(x, y)g(x−u, y−v)e^{-ik}ₓ^{x-ik}_{y}^{y} dxdy [Math 1].

13. The imaging apparatus according to claim 1, wherein, to solve the simultaneous equations, values of the Fourier components in the coordinates and values of Fourier transforms of window functions in the coordinates are substituted into the equations that express the Fourier components.

14. The imaging apparatus according to claim 1, wherein the information on the object is at least one of an absorption image, a scattering image, a differential phase image and a phase image of the object.

15. The imaging apparatus according to claim 3, wherein at least one of the equations that express the Fourier components expresses the Fourier component that stems from the period of the interference pattern.

16. The imaging apparatus according to claim 4, wherein at least one of the equations that express the Fourier components expresses the Fourier component that stems from the period of the interference pattern.

17. The imaging apparatus according to claim 3, wherein at least two of the equations that express the Fourier components express the Fourier components at two coordinates that have the relation of point symmetry about the point of origin of the wave number space.

18. The imaging apparatus according to claim 4, wherein at least two of the equations that express the Fourier components express the Fourier components at two coordinates that have the relation of point symmetry about the point of origin of the wave number space.

19. The imaging apparatus according to claim 1, wherein the shearing interferometer is a Talbot interferometer.
